(19) United States
(12) Patent Application Publication
(10) Pub. No.: US 2026/0302590 A1
(43) Pub. Date: Oct. 1, 2026

(54) ANTENNA PACKAGE AND VEHICLE-MOUNTED ANTENNA DEVICE

(71) Applicant: AUO Corporation, Hsinchu City (TW)

(72) Inventors: Hao-Lun HSIEH, Hsinchu City (TW); Xiao-Yun Li, Hsinchu City (TW); Yu-Hao Chang, Hsinchu City (TW); Fu-Yang Chen, Hsinchu City (TW); Jhih-Jhu Jhan, Hsinchu City (TW); Chun Chang, Hsinchu City (TW); Shuo-Yang Sun, Hsinchu City (TW)

(21) Appl. No.: 19/408,427

(22) Filed: Dec. 4, 2025

(30) Foreign Application Priority Data
Mar. 31, 2025 (TW) 114112457

(51) Int. Cl. H01Q 1/12; H01Q 1/02; H01Q 9/04

(52) U.S. Cl. CPC H01Q 1/1271; H01Q 1/02; H01Q 9/0407

(57) ABSTRACT

An antenna package and a vehicle-mounted antenna device are provided. The antenna package includes a first outer substrate, a second outer substrate, a surrounding wall, and an antenna module. The surrounding wall includes a support structure. The support structure is disposed between the first outer substrate and the second outer substrate. The first outer substrate, the second outer substrate, and the support structure define an accommodating space. The support structure has a support groove that communicates with the accommodating space. The antenna module is located in the accommodating space and disposed in the support groove. There are multiple gaps between the antenna module and the first outer substrate and between the antenna module and the second outer substrate.

### CROSS - REFERENCE TO RELATED APPLICATION

This application claims priority to Taiwan Application Serial Number 114112457, filed Mar. 31, 2025, which is herein incorporated by reference in its entirety.

### BACKGROUND

### Technical Field

The present disclosure relates to an antenna package and a vehicle-mounted antenna device.

### Description of Related Art

Antennas are widely used in vehicles, for example, in navigation, autonomous driving, vehicle tracking, communications, and interconnecting devices inside and outside the vehicle. Currently, antennas are integrated into vehicle windows, which not only enhance the vehicle's aesthetics, but also reduce the shielding effect of the metal vehicle body and improve signal stability since the vehicle windows are made of highly transparent materials. Therefore, the antennas integrated into the vehicle windows can also support high-band millimeter-wave or low-orbit satellite communications.

Generally, the antenna is first integrated with chips to form an antenna package, which is then integrated into the vehicle window. Therefore, improving the radiation efficiency of the antenna package and increasing the manufacturing yield of the antenna package has long been one of the goals of the related industries.

### SUMMARY

At least one embodiment of the present disclosure provides an antenna package and a vehicle-mounted antenna device having the antenna package.

The antenna package provided by at least one embodiment of the present disclosure comprises a first outer substrate, a second outer substrate, a surrounding wall, and an antenna module. The surrounding wall comprises a support structure. The support structure is disposed between the first outer substrate and the second outer substrate. The first outer substrate, the second outer substrate, and the support structure define an accommodating space. The support structure has a support groove that communicates with the accommodating space. The antenna module is located in the accommodating space and disposed in the support groove. There are multiple gaps between the antenna module and the first outer substrate and between the antenna module and the second outer substrate.

In at least one embodiment of the present disclosure, the surrounding wall further comprises a positioning structure. The positioning structure is disposed between the first outer substrate and the second outer substrate. The positioning structure, the first outer substrate, the second outer substrate, and the support structure define the accommodating space, and the positioning structure has a positioning groove. The positioning groove communicates with the accommodating space. The support groove has a first depth, and the positioning groove has a second depth. The first depth is different from the second depth. The antenna module is disposed in the positioning groove and comprises a positioning portion that matches the positioning groove.

In at least one embodiment of the present disclosure, the positioning groove further has a third depth, and the third depth is different from the second depth.

In at least one embodiment of the present disclosure, the surrounding wall further comprises a heat dissipation structure. The heat dissipation structure comprises a main body and a bump. The main body is disposed between the first outer substrate and the second outer substrate. The main body, the first outer substrate, the second outer substrate, and the support structure define the accommodating space. The bump is connected to the main body and extends from the main body in a direction away from the main body. The bump is located in the accommodating space. An edge of the antenna module is positioned against the bump, and there is a void between the antenna module and the main body, and the void communicates with the gaps.

In at least one embodiment of the present disclosure, the heat dissipation structure further comprises a bearing portion. The bearing portion is connected to the bump and extends in the direction. The antenna module is disposed on the bearing portion.

In at least one embodiment of the present disclosure, the antenna module comprises an inner substrate. A distance between the inner substrate and the first outer substrate ranges from 2 mm to 10 mm.

In at least one embodiment of the present disclosure, the antenna module comprises an antenna unit. A perpendicular projection of the surrounding wall on the first outer substrate does not overlap with a perpendicular projection of the antenna unit on the first outer substrate.

In at least one embodiment of the present disclosure, the surrounding wall is formed integrally.

In at least one embodiment of the present disclosure, the surrounding wall has an opening that communicates with the accommodating space. The antenna package further comprises a stopper member. The stopper member is disposed between the first outer substrate and the second outer substrate and closes the opening.

The vehicle-mounted antenna device provided by at least one embodiment of the present disclosure comprises the antenna package. The antenna package is integrated with a window of a vehicle body.

On the basis of the above, in the antenna package and the vehicle-mounted antenna device disclosed in the above embodiments, the antenna module is supported by the surrounding wall, and there is an appropriate thickness of air between the antenna module and outer substrates, so that the antenna module can achieve the effects of wide bandwidth and good antenna radiation efficiency.

### BRIEF DESCRIPTION OF THE DRAWINGS

For a more complete understanding of embodiments and their advantages, the description below is made with reference to the drawings.

FIG. 1 is a schematic top view of an antenna package integrated with a vehicle window according to at least one embodiment of the present disclosure;

FIG. 2 is an exploded view of a surrounding wall and a stopper member in FIG. 1;

FIG. 3 is a schematic cross-sectional view taken along line A-A' in FIG. 1;

FIG. 4 is a schematic top view of an antenna package integrated with a vehicle window according to another embodiment of the present disclosure;

FIG. 5 is a perspective view of multiple thermosetting sheets; and

FIG. 6 is a schematic cross-sectional view of the thermosetting sheets, outer substrates, and a support mold.

### DETAILED DESCRIPTION

For clearly introducing the technical features of the present disclosure below, the dimensions (such as length, width, thickness, and depth) of components (such as layers, membranes, substrates, and areas) in the figures will be scaled up disproportionately, and the number of some components will be reduced. Accordingly, the description and interpretation of the embodiments below shall not be limited to the number of components and the dimensions and shapes of the components shown in the figures, but shall encompass dimensions, shapes and deviations therebetween as a result of actual manufacturing processes and/or tolerances. For example, a flat surface shown in a figure may have a feature of roughness and/or nonlinearity, while an acute angle shown in a figure may be circular. Therefore, the components shown in the present disclosure are mainly used for schematic purposes, and are not intended to accurately depict the actual shapes of the components, nor are they used to limit the claims of the patent application.

Secondly, the words “about”, “approximately” or “substantially” appearing herein encompass not only clearly recorded values and ranges of values, but also allowable deviation ranges understood by persons of ordinary skill in the art, in which the deviation ranges may be determined by errors resulting from measurements, and the errors are due, for example, to limitations of both a measuring system and process conditions. For example, two objects (such as a plane or a trace of a substrate) are “substantially parallel” or “substantially vertical”, where “substantially parallel” and “substantially vertical” respectively represent that the parallelism and perpendicularity between the two objects may contain non-parallelism and non-perpendicularity caused by the allowable deviation ranges.

In addition, the word “about” can mean within one or more standard deviations of the above values, such as ± 30%, ± 20%, ± 10% or ± 5%. The terms “about”, “approximately” or “substantially” and the like used in the present application may be used to select acceptable deviation ranges or standard deviations based on optical, etchable, mechanical or other properties, rather than a single standard deviation to apply all of the above optical, etchable, mechanical or other properties.

Spatially relative terms used in the present disclosure, such as “under”, “below”, “above”, “over”, are used to facilitate the description of a relative relationship between one component or feature and another component or feature, as shown in the figures. The real meaning of the spatially relative terms involves other orientations. For example, when turning upside down and downside up at 180 degrees, the relationship between one component and another may change from “under” and “below” to “above” and “over”. In addition, spatially relative statements used in the present disclosure shall be similarly interpreted.

In addition, the present disclosure may be implemented or applied by means of other different specific embodiments, the details of the present disclosure may be based on different viewpoints and applications, and various embodiments can be combined, modified and changed without deviating from the idea of the present disclosure. To clarify the following embodiments, components with the same or similar functions are represented by the same number.

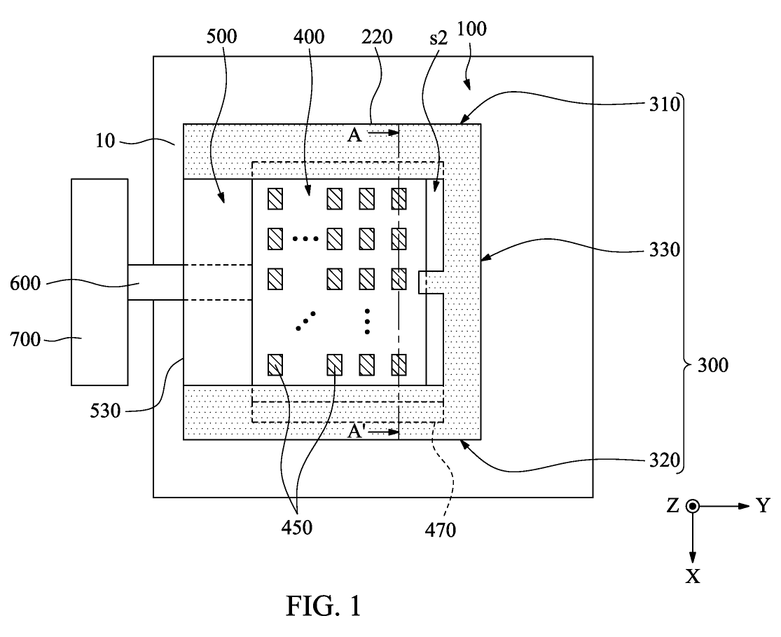

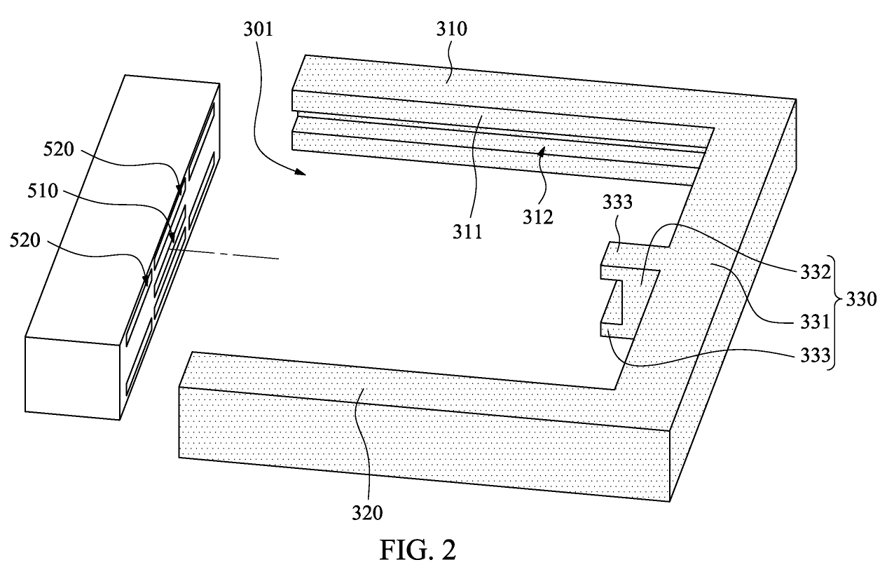

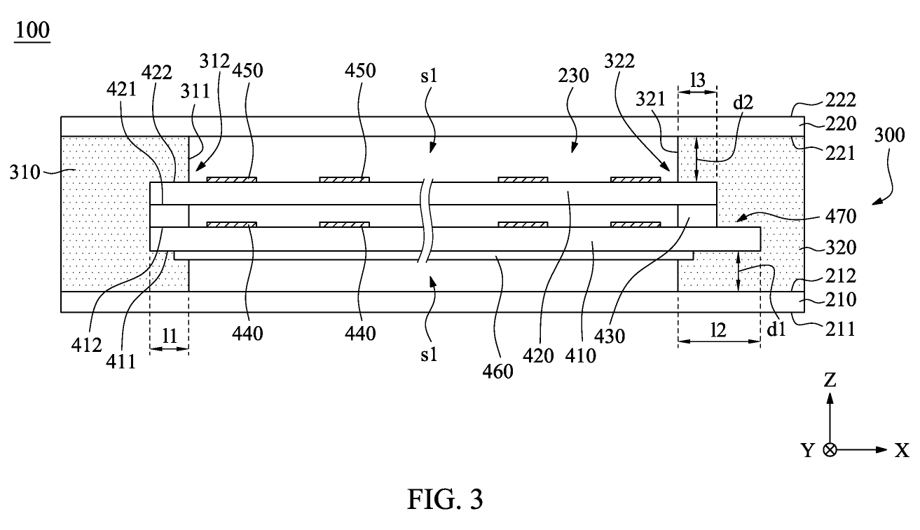

FIG. 1 is a schematic top view of an antenna package 100 integrated with a vehicle window 10 according to at least one embodiment of the present disclosure. FIG. 2 is an exploded view of a surrounding wall 300 and a stopper member 500 in FIG. 1. FIG. 3 is a schematic cross-sectional view taken along line A-A' in FIG. 1. Referring to FIGS. 1 to 3, the antenna package 100 includes outer substrates 210, 220, a surrounding wall 300, an antenna module 400, and a stopper member 500. For example, the antenna package 100 may be integrated with a vehicle body (not shown) such as a vehicle window 10 to form a vehicle-mounted antenna device, but this is not limited thereto. In other embodiments, the antenna package 100 can be integrated into the vehicle body or disposed on a housing of the vehicle body. In other embodiments, the antenna package 100 can be integrated with a window of a building or other suitable structures.

In the example of FIG. 1, the antenna module 400 of the antenna package 100 can be electrically connected to a flexible circuit board 600 through a connector (not shown), and the flexible circuit board 600 can be electrically connected to a rigid circuit board 700. It should be noted that in FIG. 1, to clearly illustrate the configuration of the antenna module 400 and the surrounding wall 300, the part of the antenna module 400 covered by the outer substrate 220 but not by the surrounding wall 300 is drawn with solid lines, and the other part of the antenna module 400 covered by both the outer substrate 220 and the surrounding wall 300 is drawn with dashed lines. To clearly illustrate the configuration of the surrounding wall 300 and the stopper member 500, FIG. 2 only illustrates the surrounding wall 300 and the stopper member 500.

The outer substrate 210 (a first outer substrate) has a surface 211 and a surface 212 that are opposite to each other in a direction Z. The outer substrate 220 (a second outer substrate) is spaced apart from the outer substrate 210 and has a surface 221 and a surface 222 that are opposite to each other in the direction Z. The surface 212 of the outer substrate 210 and the surface 221 of the outer substrate 220 face each other. The outer substrates 210 and 220 may be made of glass or other materials that are light-transmissive and have sufficient support strength.

The surrounding wall 300 is disposed between the surface 212 of the outer substrate 210 and the surface 221 of the outer substrate 220. The surrounding wall 300 may be adjacent to the edges of the outer substrates 210 and 220. The surrounding wall 300, the outer substrates 210 and 220 define an accommodating space 230, and the surrounding wall 300 has an opening 301 that communicates with the accommodating space 230. In particular, the antenna module 400 can be movably placed in the accommodating space 230 from the opening 301 and is supported by the surrounding wall 300. After the antenna module 400 is disposed in the accommodating space 230, the stopper member 500 may close the opening 301, thereby forming the antenna package 100.

In addition, the perpendicular projection of the surrounding wall 300 on the outer substrates 210 and 220 (i.e., the projection of the surrounding wall 300 in the direction Z) does not completely overlap with the outer substrates 210 and 220. Therefore, the antenna module 400 can be exposed from the surrounding wall 300. In other words, there are multiple gaps s1 between the antenna module 400 and the outer substrate 210, and between the antenna module 400 and the outer substrate 220. The material of the surrounding wall 300 may be Polyvinyl Butyral (PVB), Sentry Glas Plus (SGP), Ethylene Vinyl Acetate (EVA), or Thermoplastic Urethane (TPU).

It should be noted that the antenna package 100 can be integrated with the vehicle window 10 of the vehicle body via the outer substrates 210 and 220 and/or the surrounding wall 300. For example, the vehicle window 10 also has two layers of glass spaced apart, and the outer substrates 210 and 220 may be part of, or bonded to, the two layers of glass. When the antenna package 100 is integrated with the vehicle window 10 (e.g., a sunroof), the surface 211 of the outer substrate 210 can face the interior of the vehicle body, and the surface 222 of the outer substrate 220 can face the exterior of the vehicle body.

The antenna module 400 may include two inner substrates 410, 420, a support wall 430, multiple antenna units 440, 450, and a redistribution layer structure 460. The inner substrates 410 and 420 may be located at intervals between the outer substrates 210 and 220 and be arranged in sequence along the direction Z. The inner substrate 410 has a surface 411 and a surface 412 that are opposite to each other in the direction Z. The inner substrate 420 has a surface 421 and a surface 422 that are opposite to each other in the direction Z. The surface 411 of the inner substrate 410 faces the surface 212 of the outer substrate 210. The surface 412 of the inner substrate 410 faces the surface 421 of the inner substrate 420. The surface 422 of the inner substrate 420 faces the surface 221 of the outer substrate 220.

The support wall 430 is disposed between the surface 412 of the inner substrate 410 and the surface 421 of the inner substrate 420. The antenna units 440 are distributed at intervals on the surface 412 of the inner substrate 410 and may be arranged in directions X and Y to form an array. The antenna units 450 are distributed at intervals on the surface 422 of the inner substrate 420, and the projections thereof in the direction Z (the projections on the inner substrate 410) respectively overlap with the projections of the antenna units 440 in the direction Z (the projections on the inner substrate 410). For example, the antenna units 440 and 450 may be metal sheets such as patch antennas. The shape of the antenna units 440 and 450 may be roughly rectangular, but is not limited thereto. In other embodiments, the shape of the antenna units 440 and 450 may also be circular, triangular, annular, or other polygonal.

The redistribution layer structure 460 is disposed on the surface 411 of the inner substrate 410. An electronic component (not shown) such as a chip may be electrically connected to a pad of an outer wiring layer of the redistribution layer structure 460. The chip can provide a feed signal to be transmitted to the redistribution layer structure 460. The energy of the feed signal can be coupled to the antenna units 440 and 450, causing the antenna module 400 to radiate electromagnetic waves.

It should be noted that the antenna units 440 resonate with the antenna units 450 to increase the operating bandwidth of the antenna module 400. In other embodiments, the antenna module may not have the inner substrate 420 and the multiple antenna units 450. For example, the antenna module 400 can operate simultaneously in the Ka band (26.5 GHz-40 GHz) and the Ku band (12 GHz-18 GHz). In other embodiments, the antenna module without the antenna units 450 operates only in the Ka band.

The material of the inner substrates 410 and 420 can be similar to that of the outer substrates 210 and 220, such as glass, or other materials that are light-transmissive and have sufficient support strength. The material of the support wall 430 can be similar to that of the outer substrates 210 and 220 or the surrounding wall 300, such as glass, PVB, SGP, EVA, or TPU.

In detail, the surrounding wall 300 may include a support structure 310. The support structure 310 is disposed between the surface 212 and the surface 221. The support structure 310, the outer substrates 210 and 220 collectively define the accommodating space 230. The support structure 310 has an inner wall surface 311 surrounding the antenna module 400 and a support groove 312 recessed from the inner wall surface 311. The support groove 312 communicates with the accommodating space 230. The edge of the antenna module 400 may be disposed in the support groove 312 so as to be supported by the support structure 310, and the antenna module 400 maintains an appropriate distance from the outer substrates 210 and 220.

It is worth mentioning that the distance d1 between the surface 411 of the inner substrate 410 and the surface 212 of the outer substrate 210 may be in the range of 2 mm to 10 mm, for example, in the range of 4 mm to 6 mm. Similarly, the distance d2 between the surface 422 of the inner substrate 420 and the surface 221 of the outer substrate 220 may be in the range of 2 mm to 10 mm, for example, in the range of 4 mm to 6 mm. Because the dielectric constant of air is relatively low, there are appropriate thicknesses of air between the antenna module 400 and the outer substrate 210 and between the antenna module 400 and the outer substrate 220, so that the antenna module 400 can achieve the effects of wide bandwidth and good antenna radiation efficiency.

Furthermore, the surrounding wall 300 may further include a positioning structure 320, and the antenna module 400 may also include a positioning portion 470. The perpendicular projection of the positioning structure 320 on the outer substrates 210 and 220 (the perpendicular projection in the direction Z) does not overlap with the perpendicular projection of the support structure 310 on the outer substrates 210 and 220 (the perpendicular projection in the direction Z).

The positioning structure 320 is similar to the support structure 310, and the positioning structure 320 is also disposed between the surface 212 and the surface 221. The positioning structure 320, the support structure 310, and the outer substrates 210 and 220 collectively define the accommodating space 230. The positioning structure 320 also has an inner wall surface 321 surrounding the antenna module 400 and a positioning groove 322 recessed from the inner wall surface 321. The positioning groove 322 communicates with the accommodating space 230. The edge of the antenna module 400 may also be disposed in the positioning groove 322. In other words, the positioning structure 320 also has the function of supporting the antenna module 400. In particular, the positioning structure 320 differs from the support structure 310 in that the depth l2 (a second depth) of the positioning groove 322 is different from the depth l1 (a first depth) of the support groove 312. For example, as shown in FIG. 3, the depth l2 of a part of the positioning groove 322 is greater than the depth l1 of the support groove 312.

The positioning portion 470 of the antenna module 400 can match the positioning groove 322. In other words, the shape and size of the positioning portion 470 can be similar to those of the positioning groove 322. Therefore, when the antenna module 400 is disposed in the positioning groove 322, the positioning portion 470 may be accommodated in the positioning groove 322. Since the depth l2 of the positioning groove 322 is different from the depth l1 of the support groove 312, the fool-proof effect may be achieved when the antenna module 400 is disposed in the accommodating space 230. The positioning portion 470 may be a part of the edge structure of the antenna module 400.

On the other hand, the positioning groove 322 may have two different depths l2 and l3. Therefore, even if the depth l3 of a part of the positioning groove 322 is the same as the depth l1 of the support groove 312, the fool-proof effect can still be achieved. For example of FIG. 3, the inner substrate 410 at the positioning portion 470 protrudes relative to the inner substrate 420, and the length of the protrusion may be in the range of 1% to 20% of the width of the inner substrate 420. In other embodiments, the inner substrate 420 at the positioning portion 470 protrudes relative to the inner substrate 410, and the length of the protrusion may be in the range of 1% to 20% of the width of the inner substrate 410.

Furthermore, the surrounding wall 300 may further include a heat dissipation structure 330. The perpendicular projection of the heat dissipation structure 330 on the outer substrates 210 and 220 (the perpendicular projection in the direction Z) does not overlap with the perpendicular projections of the support structure 310 and the positioning structure 320 on the outer substrates 210 and 220 (the perpendicular projections in the direction Z). The heat dissipation structure 330 is connected between the support structure 310 and the positioning structure 320.

The heat dissipation structure 330 includes a main body 331, a bump 332, and multiple bearing portions 333. The main body 331 is similar to the support structure 310 and the positioning structure 320. The main body 331 is also disposed between the surface 212 and the surface 221. The main body 331, the positioning structure 320, the support structure 310, and the outer substrates 210 and 220 collectively define the accommodating space 230. The main body 331 may be connected between the support structure 310 and the positioning structure 320. The bump 332 is located in the accommodating space 230. The bump 332 is connected to the main body 331 and extends from the main body 331 in a direction away from the main body 331 (e.g., a direction opposite to the direction Y).

The bearing portions 333 are connected to the bump 332 at intervals in the direction Z and extend from the bump 332 in a direction away from the bump 332 (e.g., the direction opposite to the direction Y). That is, the extending direction of the bearing portions 333 is similar to the extending direction of the bump 332. When the antenna module 400 is disposed in the accommodating space 230, part of the edge of the antenna module 400 is disposed between the bearing portions 333 and is positioned against the bump 332, so that there are multiple voids s2 between the antenna module 400 and the main body 331. The voids s2 communicate with the gaps s1 to form channels for air flow.

In FIGS. 1 to 3, the heat dissipation structure 330 includes two bearing portions 333, but is not limited thereto. In other embodiments, the heat dissipation structure 330 may not include any bearing portion 333. In other embodiments, the heat dissipation structure 330 may include only one bearing portion 333 for the antenna module 400 to be disposed. In addition, in other embodiments, the heat dissipation structure 330 may include multiple bumps 332, so that the antenna module 400 is positioned against the bumps 332 without being easily tilted. For example, the bumps 332 may also be connected near the intersection of the main body 331 and the support structure 310, or near the intersection of the main body 331 and the positioning structure 320. It should be noted that the number and relative configuration positions of the support structure 310, the positioning structure 320, and the heat dissipation structure 330 in the surrounding wall 300 may be changed according to actual demands without limitation. For example, in other embodiments, the surrounding wall 300 only includes the support structure 310 and presents a U-shape in the top view direction (the direction Z). In other embodiments, the surrounding wall 300 only includes the support structure 310 and the heat dissipation structure 330, and the support structure 310 and the heat dissipation structure 330 are connected.

The stopper member 500 may be movably disposed in the accommodating space 230 to close the opening 301 and prevent the antenna module 400 from moving in the accommodating space 230. It should be noted that the stopper member 500 may be completely disposed in the accommodating space 230 or partially protrudes from the accommodating space 230 without limitation. For the examples of FIGS. 1 to 3, the stopper member 500 is completely disposed in the accommodating space 230, and the edge 530 of the stopper member 500 is flush with the edges of the outer substrates 210 and 220. In other embodiments, the edge 530 of the stopper member 500 is retracted into the accommodating space 230 relative to the edges of the outer substrates 210 and 220. In other embodiments, the edge 530 of the stopper member 500 protrudes from the accommodating space 230 relative to the edges of the outer substrates 210 and 220.

The stopper member 500 may have a through-hole 510 and multiple ventilation holes 520, and the through-hole 510 and the ventilation holes 520 communicate with the accommodating space 230. For example, the flexible circuit board 600 may pass through the through-hole 510 to be electrically connected to the antenna module 400 and the rigid circuit board 700. In particular, the ventilation holes 520, together with the gaps s1 and the voids s2, may form channels for air flow and convection. The stopper member 500 may be made of acrylic, silica gel, or rubber. It is worth mentioning that when the antenna module 400 needs to be replaced, the stopper member 500 may be removed from the accommodating space 230 without damaging the structures of the stopper member 500 and the surrounding wall 300, and the antenna module 400 may then be removed through the opening 301 for replacement.

When the antenna module 400 is supported via the surrounding wall 300, the perpendicular projection of the surrounding wall 300 on the outer substrate 210 or the outer substrate 220 does not overlap with the perpendicular projections of the antenna units 440 and 450 on the outer substrate 210 or the outer substrate 220. Therefore, the surrounding wall 300 does not affect the radiation efficiency of the antenna module 400. In addition, heat energy generated by the antenna module 400 can be dissipated through the gaps s1, the voids s2, and the ventilation holes 520 with the flow of air, thereby reducing heat accumulation and achieving a good heat dissipation effect.

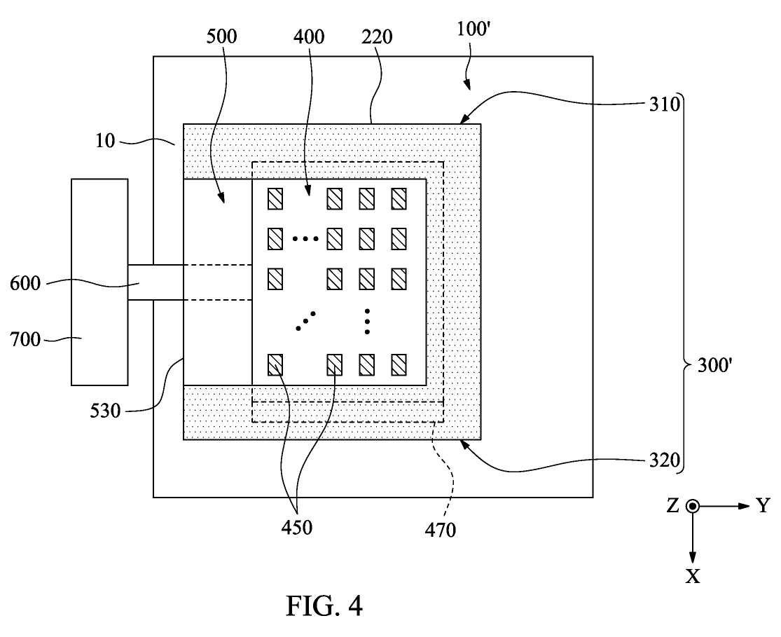

FIG. 4 is a schematic top view of an antenna package 100' integrated with a vehicle window 10 according to another embodiment of the present disclosure. Referring to FIG. 4, the antenna package 100' of FIG. 4 is similar to the antenna package 100 of FIG. 1. The difference is that the surrounding wall 300' of FIG. 4 only includes a support structure 310 and a positioning structure 320. The support structure 310 and the positioning structure 320 are connected and present a U-shape in the top view direction (the direction Z). The antenna module 400 may also be supported by the support structure 310 and the positioning structure 320, with appropriate thicknesses of air between the antenna module 400 and the outer substrate 210 and between the antenna module 400 and the outer substrate 220 (FIG. 3), so that the antenna module 400 can achieve the effects of wide bandwidth and good antenna radiation efficiency. In addition, due to the positioning structure 320, the fool-proof effect can also be achieved when the antenna module 400 is disposed in the accommodating space 230 (FIG. 3).

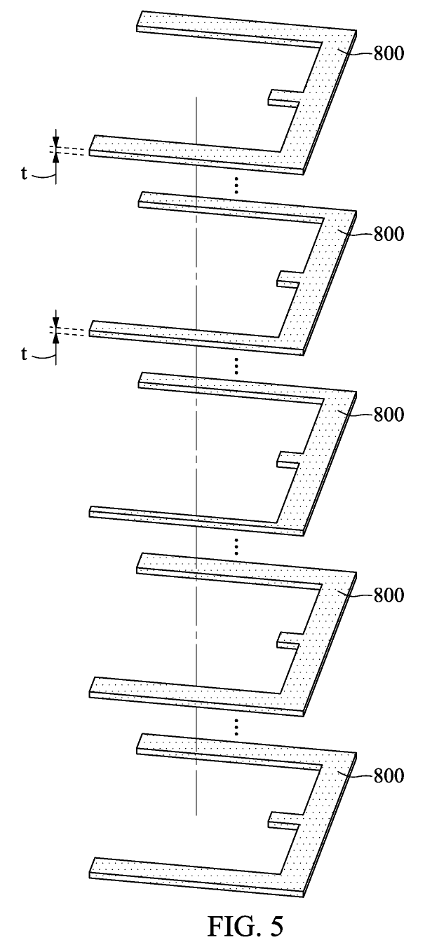

FIG. 5 is a perspective view of multiple thermosetting sheets 800, in which the thermosetting sheets 800 are used to manufacture the surrounding wall 300 of FIG. 1. Referring to FIGS. 1, 2, 3, and 5, particularly, the surrounding wall 300 may be formed integrally. In other words, in the surrounding wall 300, there is no adhesive among the support structure 310, the positioning structure 320, and the heat dissipation structure 330. The support structure 310, the positioning structure 320, and the heat dissipation structure 330 are connected to each other. The surrounding wall 300 may be formed by stacking multiple thermosetting sheets 800. For example, the shapes of the multiple thermosetting sheets 800 may be pre-cut to resemble the shapes of multiple stacked layers of the surrounding wall 300 along the direction Z. The thickness t of each thermosetting sheet 800 may be in the range of 0.2 mm to 0.8 mm, for example, 0.38 mm or 0.76 mm. In addition, the thicknesses t of the thermosetting sheets 800 may be the same or different, without limitation. The material of the thermosetting sheets 800 may be PVB, SGP, EVA, or TPU. It should be noted that the one-piece construction in the surrounding wall 300 is just one kind of manufacturing method, but this is not limited thereto. In other embodiments, the surrounding wall 300 may not be formed integrally. The support structure 310, the positioning structure 320, and the heat dissipation structure 330 may be joined using adhesives.

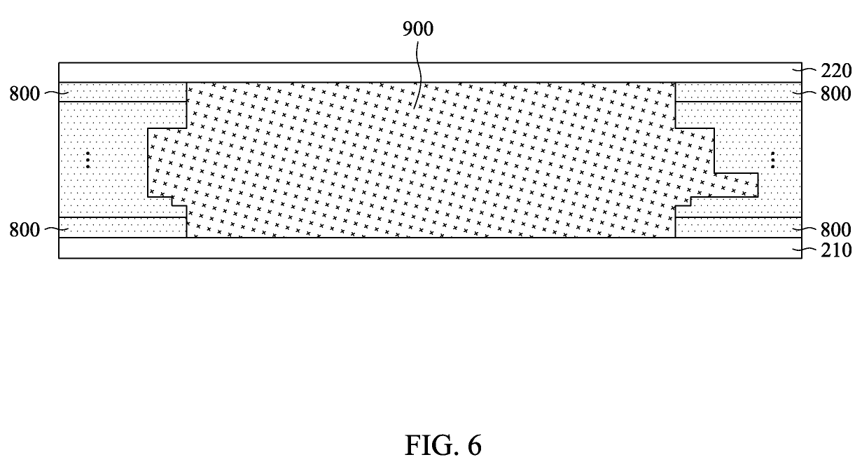

FIG. 6 is a schematic cross-sectional view of multiple thermosetting sheets 800, outer substrates 210 and 220, and a support mold 900, in which the thermosetting sheets 800, the outer substrates 210 and 220, and the support mold 900 are used to manufacture the antenna package 100 of FIG. 1. Referring to FIGS. 1, 3, 5, and 6, the cut thermosetting sheets 800 are stacked between the outer substrates 210 and 220, and the support mold 900 is placed between the thermosetting sheets 800 and the outer substrates 210 and 220, and a hot press bonding process is performed. It is worth mentioning that the shape and size of the support mold 900 can be consistent with the shape and size of the accommodating space 230. The support mold 900 can hold the heated thermosetting sheets 800 in place to maintain the shape of the surrounding wall 300.

The surface material of the support mold 900 can be an anti-stick material such as Polytetrafluoroethylene (PTFE). After the thermosetting sheets 800 form the surrounding wall 300 combined with the outer substrates 210 and 220, the support mold 900 can be removed without adhering to the surrounding wall 300. Since the antenna module 400 can be placed in the accommodating space 230 only after the surrounding wall 300 is combined with the outer substrates 210 and 220, the antenna module 400 can avoid undergoing the high-temperature and high-pressure hot press bonding process, thereby preventing damage (e.g., cracking of the inner substrates 410 and 420). This improves the manufacturing yield of the antenna package 100.

In summary, in the antenna packages disclosed in the above embodiments, the antenna module is supported by the surrounding wall, and there are appropriate thicknesses of air between the antenna module and the outer substrates, so that the antenna module can achieve the effects of wide bandwidth and good antenna radiation efficiency. Secondly, the positioning structure of the surrounding wall also has a fool-proof design, so that the fool-proof effect can be achieved when the antenna module is disposed in the accommodating space. Moreover, the heat dissipation structure of the surrounding wall can form channels for air flow, so as to avoid the accumulation of heat energy generated by the antenna module, thereby achieving the effect of accelerated heat dissipation. In addition, the antenna module can be assembled with the outer substrates, the surrounding wall and the stopper member after the surrounding wall is combined with the outer substrates, so as to avoid the high-temperature and high-pressure hot press bonding process, thereby improving the manufacturing yield of the antenna package.

Although the present disclosure has been disclosed as above in embodiments, the embodiments are not intended to limit the present disclosure, and those of ordinary skill in the art may make some changes and embellishments within the spirit and scope of the present disclosure, therefore, the scope of protection of the present disclosure shall be defined in the attached claims.

What is claimed is:

1. An antenna package, comprising:
a first outer substrate;
a second outer substrate;
a surrounding wall, comprising:
a support structure disposed between the first outer substrate and the second outer substrate, wherein the first outer substrate, the second outer substrate, and the support structure define an accommodating space, and the support structure has a support groove that communicates with the accommodating space; and
an antenna module located in the accommodating space and disposed in the support groove, wherein there are a plurality of gaps between the antenna module and the first outer substrate and between the antenna module and the second outer substrate.

2. The antenna package according to claim 1, wherein the surrounding wall further comprises:
a positioning structure disposed between the first outer substrate and the second outer substrate, wherein the positioning structure, the first outer substrate, the second outer substrate, and the support structure define the accommodating space, and the positioning structure has a positioning groove that communicates with the accommodating space;
wherein the support groove has a first depth, and the positioning groove has a second depth, and the first depth is different from the second depth; and
wherein the antenna module is disposed in the positioning groove and comprises a positioning portion that matches the positioning groove.

3. The antenna package according to claim 2, wherein the positioning groove further has a third depth, and the third depth is different from the second depth.

4. The antenna package according to claim 1, wherein the surrounding wall further comprises:
a heat dissipation structure comprising:
a main body disposed between the first outer substrate and the second outer substrate, wherein the main body, the first outer substrate, the second outer substrate, and the support structure define the accommodating space; and
a bump connected to the main body and extending from the main body in a direction away from the main body, wherein the bump is located in the accommodating space; and
wherein an edge of the antenna module is positioned against the bump, and there is a void between the antenna module and the main body, and the void communicates with the gaps.

5. The antenna package according to claim 4, wherein the heat dissipation structure further comprises a bearing portion connected to the bump and extending in the direction, and the antenna module is disposed on the bearing portion.

6. The antenna package according to claim 1, wherein the antenna module comprises an inner substrate, and a distance between the inner substrate and the first outer substrate ranges from 2 mm to 10 mm.

7. The antenna package according to claim 1, wherein the antenna module comprises an antenna unit, and a perpendicular projection of the surrounding wall on the first outer substrate does not overlap with a perpendicular projection of the antenna unit on the first outer substrate.

8. The antenna package according to claim 1, wherein the surrounding wall is formed integrally.

9. The antenna package according to claim 1, wherein the surrounding wall has an opening that communicates with the accommodating space;
wherein the antenna package further comprises:
a stopper member disposed between the first outer substrate and the second outer substrate and closing the opening.

10. A vehicle-mounted antenna device, comprising:
an antenna package, comprising:
a first outer substrate;
a second outer substrate;
a surrounding wall, comprising:
a support structure disposed between the first outer substrate and the second outer substrate, wherein the first outer substrate, the second outer substrate, and the support structure define an accommodating space, and the support structure has a support groove that communicates with the accommodating space; and
an antenna module located in the accommodating space and disposed in the support groove, wherein there are plurality of gaps between the antenna module and the first outer substrate and between the antenna module and the second outer substrate; and
wherein the antenna package is integrated with a window of a vehicle body.

11. The vehicle-mounted antenna device according to claim 10, wherein the surrounding wall further comprises:
a positioning structure disposed between the first outer substrate and the second outer substrate, wherein the positioning structure, the first outer substrate, the second outer substrate, and the support structure define the accommodating space, and the positioning structure has a positioning groove that communicates with the accommodating space;
wherein the support groove has a first depth, and the positioning groove has a second depth, and the first depth is different from the second depth; and
wherein the antenna module is disposed in the positioning groove and comprises a positioning portion that matches the positioning groove.

12. The vehicle-mounted antenna device according to claim 11, wherein the positioning groove further has a third depth, and the third depth is different from the second depth.

13. The vehicle-mounted antenna device according to claim 10, wherein the surrounding wall further comprises:
a heat dissipation structure comprising:
a main body disposed between the first outer substrate and the second outer substrate, wherein the main body, the first outer substrate, the second outer substrate, and the support structure define the accommodating space; and
a bump connected to the main body and extending from the main body in a direction away from the main body, wherein the bump is located in the accommodating space; and
wherein an edge of the antenna module is positioned against the bump, and there is a void between the antenna module and the main body, and the void communicates with the gaps.

14. The vehicle-mounted antenna device according to claim 13, wherein the heat dissipation structure further comprises a bearing portion connected to the bump and extending in the direction, and the antenna module is disposed on the bearing portion.

15. The vehicle-mounted antenna device according to claim 10, wherein the antenna module comprises an inner substrate, and a distance between the inner substrate and the first outer substrate ranges from 2 mm to 10 mm.

16. The vehicle-mounted antenna device according to claim 10, wherein the antenna module comprises an antenna unit, and a perpendicular projection of the surrounding wall on the first outer substrate does not overlap with a perpendicular projection of the antenna unit on the first outer substrate.

17. The vehicle-mounted antenna device according to claim 10, wherein the surrounding wall has an opening that communicates with the accommodating space;
wherein the antenna package further comprises:
a stopper member disposed between the first outer substrate and the second outer substrate and closing the opening.
